(19) United States
(12) Patent Application Publication
(10) Pub. No.: US 2010/0029803 A1
(43) Pub. Date: Feb. 4, 2010

(54) HETEROPHASIC BIOPOLYMER COMPOSITION

(75) Inventors: Jukka Veli Seppälä, Helsinki (FI); Minna Mari Turunen, Espoo (FI)

Correspondence Address: CHERNOFF, VILHAUER, MCCLUNG & STENZEL, LLP, 601 SW Second Avenue, Suite 1600, Portland, OR, 97204, US

(73) Assignee: JVS-POLYMERS OY, Espoo (FI)

(21) Appl. No.: 12/518,698

(22) PCT Filed: Dec. 5, 2007
(86) PCT No.: PCT/FI07/00286

§ 371 Date: Jun. 11, 2009

(30) Foreign Application Priority Data
Dec. 15, 2006 (FI) 20061117

(51) Int. Cl. C08F 2/46; C08L 83/07; C08K 3/32; C08K 3/34; C08K 3/22; C08K 3/08; C08G 77/20

(52) U.S. Cl. 522/172; 524/588; 524/417; 524/447; 524/437; 524/436; 524/440; 524/441; 528/32; 977/773

(57) ABSTRACT

In a heterophasic polymer composition according to the invention the polymer is a biopolymer. Typically it is a composite of a polyester or copolyester consisting substantially of lactic acid, and an another phase that is a reinforcing agent or filler or another layered structure or surface. By using the composition according to the invention and preparation method of the invention especially good mechanical properties can be achieved for these biopolymer composites through producing very high interfacial adhesions between the phases.

There have been already for a long time known several methods to increase the strength of the polymeric materials by adding reinforcing or toughening components into them, such as inorganic fillers or reinforcing fibres like glass fibres. This is especially known in connection to unsaturated polyesters and epoxy resins but increasingly these reinforcements are applied in connection to thermoplastic polymers.

In the technology of strong composite materials it is of essential importance that there is good adhesion between the matrix polymeric component and the heterophasic reinforcing or filling agent. This prerequisite is essential also when there is a target to increase stiffness or fire retardation, or for any other such reason to increase substantial amount of heterophasic components in a polymeric material. This often results in unwanted brittleness, especially in case the interfacial adhesion between the polymer and the heterophasic component is not at a sufficient level.

It is well known to utilize coupling agents, for example, between glass and unsaturated polyester resin to produce interfacial adhesion. This technology has been well described in textbooks on the field, like Saarela, O. et al., Komposiittirakenteet, Finnish Plastics Federation, Helsinki 2003, and Plueddemann, E. P., Silane Coupling Agents 2^{nd} ed., Plenum Press, New York N.Y. 1991. For functionality of coupling agents it is essential, that coupling agents have the capability to chemically react with the heterophasic material. In the case of unsaturated polyesters the most common group of the coupling agents is various vinyl silanes having at one end of their molecules a double bond that polymerizes by free radical mechanism and thus participates in hardening of the resin, and at the other end a functional group capable to react with the silanol groups of the glass fibre surface, such as an alkoxy group. As an example one can mention vinyltrimethoxysilane.

There are many alternatives for a silane coupling agent due to the fact that the chemistry of silicon is so versatile. Of the known chemically reactive silanes known in the composite technology one can mention, for example, vinyl-, methacrylate-, epoxy-, mercapto-, and ureidosilanes.

Another field essentially connected to the field of the invention is the coupling of the polymer to the surfaces of other materials like metal or glass surfaces. Also in this case interfacial adhesion is of essential importance. For this purpose specific glues or coupling agents have been developed, in addition to so called compatibilisators which both are extensively published in the literature.

Adhesion characteristics of polyolefin resins are reported to be improved by grafting, e.g. grafting to polyethylene and polypropylene in patent application PCT/FI84/0015. Also in this case the final adhesion is formed when a silicon-containing functional group of a polymer, such as alcoxy silane, reacts with a heterophasic surface like another polymer, filler or reinforcing agent.

It is also important in development of new polymer based materials, whether polyolefins or so called biopolymers, to be able to utilize them in heterophasic composite materials. Thus they may appear in the form of multilayered structures, filler containing blends or structures containing reinforcing fibres. In these connections it is, however, not self-evident that there is sufficient adhesion between the polymer and the heterophasic component, i.e. the filler, the reinforcing agent or the surfaces of the layered structure. In fact this issue often is the main reason leading to low mechanical strength values and poor performance of the product. On the other hand one can say that interfacial adhesion good enough can produce surprisingly high mechanical strength values typical for many composite materials.

The reason that there usually emerge difficulties to reach good interfacial adhesion properties in the composite technology of above mentioned relatively new polymer groups, is the basic difference between their chemistry and the chemistry of unsaturated polyesters.

By adapting this now described invention we have reached surprisingly high levels of adhesion in heterophasic polymer systems, also in the case of biopolymers, and most surprisingly in the case of saturated polymers, i.e. polymers lacking double bonds. In our present invention, namely, we have been surprisingly been able to prove the chemical coupling of double bond containing coupling agents like vinyl silane or methacrylsilane to the polymer through radical reaction with the labile hydrogen in the polymer structure. A covalent bond can then be formed between the phases through the additional reaction of a silicon functional group of a vinyl silane type coupling agent reacts with the other phase of a heterophasic polymer composition, typically, for example, methoxysilane reacts with the silanol groups of a glass particle surface or with the oxide groups on a metal surface.

Surprisingly again, we have observed that similar improvement of interfacial adhesion is achieved also in the case of unsaturated biopolymers of thermoset type provided that they have labile hydrogen atoms in their molecular structure. In this case the radical formation, and the grafting through it, is performed preferably during the processing step, not just within the homogenization of the heterophasic polymer composition. As an example of unsaturated biopolymer can be taken a polymer composition according to patent FI 115217B (Tuominen, J. et al., Fortum Oyj) which discloses polymer chains with double bonds in the molecular structure.

As examples of silane compounds functioning according to the invention one can mention vinyltriethoxysilane, vinyltrimethoxysilane, vinyl(2-methoxyethoxy)silane, γ-metakryloksipropyltrimethoxysilane, just to mention a few without excluding any other corresponding compounds.

It is typical for labile hydrogen atoms in polymeric molecular structures that they can relatively easily be detached from polymer chains, especially in presence of free radicals. Thus free radical reactions enable grafting that is based on utilization of labile hydrogen atoms, i.e. attaching side group molecules onto polymer chains. Labile hydrogen atoms exist in polymers, for example, in the case when hydrogen atoms are attached onto tertiary carbon atoms, i.e. they are so called methylidyne hydrogens. Also the CH₂ groups attached onto saturated hydrocarbon chains are fairly labile in the sense of this invention because their reactivity can also be utilized in successful grafting onto polymer chains. As examples one can mention polylactides and other polymers having lactic acid units in their chain structures where lactic acid monomers bring along reactive labile hydrogen atoms attached to tertiary carbon atoms.

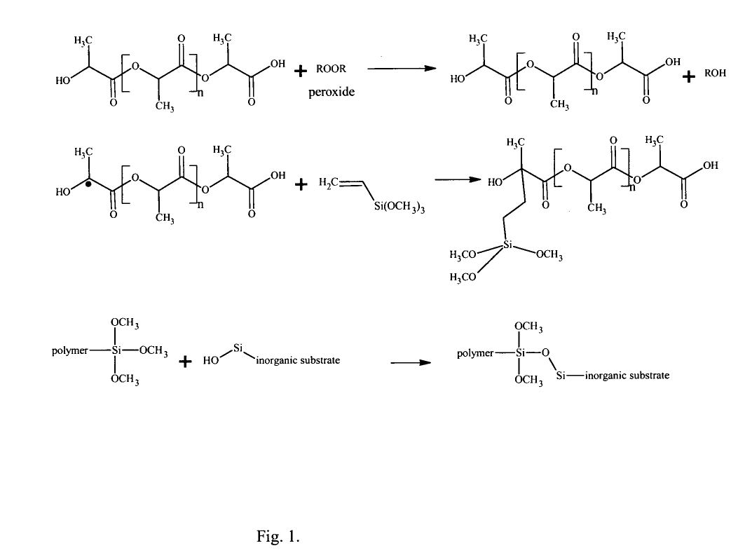

FIG. 1 presents the free radical formation and grafting reaction onto a lactic acid based polymer and coupling with the inorganic substrate such as glass in which radicals form through peroxide addition, and grafting by reaction with vinyl trimethoxysilane.

Especially advantageous form of application of the invention is such that into a biopolymer component is blended in a melt mixer device at an elevated temperature a heterophasic component, such as cut glass fibres, and in addition simultaneously a small amount, typically less than 5 wt-%, double bonds containing functional silane compound is added, and furthermore is added a small amount, typically less than 0.5 wt-%, peroxide compound that decomposes at the melt mixing temperature forming free radicals. Thus all the coupling reactions are set to occur simultaneously, and a good interfacial adhesion will be achieved which leads to high strength of the produced composite material.

Alternatively the above mentioned method for preparation can be carried out in such a way that the melt blending is done at a somewhat lower temperature than the final specimen processing temperature, e.g. compression moulding. In this embodiment of the invention both the free radical reaction and the reaction of the double bond with the labile hydrogen in the polymer occur only in the connection of specimen processing. The result in this is, however, chemical bonding between interfaces and extremely good strength for thus prepared composite material.

Furthermore another specific embodiment of the invention is such where the heterophasic component, such as glass fibres, glass particles, or an inorganic filler, or a metal surface, or a metal oxide surface has first been brought in contact with a functional silane compound containing double bond in its molecular structure, typically with such as vinyltrimethoxysilane. The contact may occur, say, in solution state. In this case the silane functionality reacts chemically with the surface of the heterophasic component. The good adhesion through chemical coupling is then achieved when the heterophasic component which thus has been treated with unsaturated silane compound according to the invention is blended at an elevated temperature with a free radical initiator and a biopolymer containing a labile hydrogen in its molecular structure, e.g. with polylactide. This leads to clearly detectable improved strength properties in comparison with the case in which untreated heterophasic component is used in the same manner. A special benefit of this embodiment is that the amount of the functional silane compound is small due to the reason that it is in this case needed only on the interfaces.

### EXAMPLES

### Example 1

Heterogenization of Composite and Grafting

(Thermoplastic Polymer/Glass Fiber/Vinyltrimethoxysilane)

The melt mixing of the composite material was done in a kneading type plastics melt mixing device (Mantechno). In the beginning 15 g (43 wt-%) of thermoplastic poly(caprolactone/DL-lactide) copolymer (P(CL95/DLLA5), MW=95000, Mn=52300) is melted in the melt mixing device at a temperature of 80° C. for two minutes with an agitation speed of 50 rpm and with a torque value between 0.8-1.0 Ncm. Then 20 g (57 wt-%) chopped glass fibres of length 4.5 mm (MaxiChop 3299) was added within a time period of 1 min when the torque values varied between 0.8 and 2.6 Ncm, and at a time point of three minutes the melt mixing temperature was increased to 100° C. After five minutes 5 wt-% vinyltrimethoxysilane was added (amount calculated on the weight of the polymer), and at the time of 6 min 1 wt-% of dibenzoylperoxide (Lucidol) was added, and the temperature was increased to 120° C. The mixing was stopped at the time of nine minutes when a hot grafted composite melt was recovered. At the room temperature the composite material was hard and tough material. At an elevated temperature it was possible to melt process the composite material into desired forms, e.g. into sheets or plates. The tensile modulus, tensile strength and elongation of the thus prepared composite material were 1260 MPa, 21 MPa and 6.7%, respectively, whereas the similar ungrafted reference sample showed the above tensile values 426 MPa, 2.8 MPa and 1.2%, respectively.

### Example 2

(Thermoplastic Polymer/Bioactive Glass Particles/Vinyltrimethoxysilane)

The melt mixing and homogenisation of the composite material was done in a melt mixing device (Mantechno) according to Example 1 but by using the following amounts and components: 20 g (50 wt-%) thermoplastic poly(caprolactone/DL-lactide) copolymer (P(CL95/DLLA5), MW 95000, Mn=52300), 20 g (50 wt-%) bioactive glass (particle size less than 90 μm), 5 wt-% vinyltrimethoxysilane and 1 wt-% dibenzoyl peroxide. As the end product a hard and tough composite material was obtained having modulus, tensile strength and elongation values 433 MPa, 9 MPa and 0.7%, respectively.

### Example 3

(Thermoplastic Biopolymer/Bioactive Glass Fibers/Vinyltrimethoxysilane)

The melt mixing and homogenisation of the composite material was done in a melt mixing device (Mantechno) according to Example 1, but by using the following amounts and components: 15 g (50 wt-%) thermoplastic poly(caprolactone/DL-lactide) copolymer (P(CL95/DLLA 5), MW 95000, Mn=52300), 20 g (50 wt-%) bioactive glass fibers in chopped form (length 10 mm), 5 wt-% vinyltrimethoxysilane and 1 wt-% dibenzoyl peroxide. As the end product a hard and tough composite material was obtained, having modulus, tensile strength and elongation values 1180 MPa, 17 MPa and 3%, respectively, whereas the corresponding values for a ungrafted reference sample were 560 MPa, 2 MPa and 1.2% respectively.

### Example 4

Homogenisation

(Thermoset Type Lactic Acid Based Biopolymer/Glass Fibers/Vinyltrimethoxysilane)

The mixing and homogenisation of the components of the composite materials was done in a melt mixer device (Mantechno). In the beginning 35 g (60 wt-%) of crosslinkable lactic acid based polymer (MW=3000) was melted in the mixer at 50° C. for two minutes with rotational speed of 50 rpm and with torque values varying between 0.4-1 Ncm. Chopped glass fibers (MaxChop 3299) was added 23.3 g within one minute, torque values varying between 0.8-2.0 Ncm. Thereafter at the time of 5 min 2 wt-% of vinyltrimethoxysilane (calculated on the amount of polymer) was added, and at the time of 6 min 1 wt-% dibenzoylperoxide (Lucidol) was added and the temperature was increased to 120° C. The blending was ended at 9 min time point when a hot, plastic, mouldable and homogeneous mass was obtained. At the room temperature the pudding-like mass was not at all sticky, and it was easy to give any shapes to it.

### Example 5

Grafting and Crosslinking of the Composite

The pudding-like material received according to Example 4 was grafted and crosslinked into network by compression moulding at an elevated temperature. 5 g of the composite mass was weighed on a siliconized paper and was compression moulded at 120° C. for 5 min in a table press (3000 psi) using a ring shaped mould frame. As a result a hard and tough composite plate with even surfaces was obtained. It had modulus, tensile strength and tensile elongation values 3050 MPa, 39 MPa and 1.6%, respectively. The modulus, tensile strength and elongation values of an untreated reference sample were 2900 MPa, 21 MPa and 1%, respectively.

1. Heterophasic polymer composition substantially consisting of hydroxyacid based structural units and glass or bioactive glass or metallic particles or surfaces as a heterophasic component, wherein the interfacial adhesion between the phases has been improved by grafting with a silicon compound containing double bond onto the polymeric component through a reaction with its labile hydrogen atom and attached on the heterophasic component through a reaction of a functional group of the silicon compound and thus improves interfacial adhesion between phases.

2. A composition according to claim 1 wherein the double bond containing silicon compound has been grafted by the use of heat, added peroxide, photoinitiation or mechanical-chemical initiation or by using a combination of these, the peroxide amount being advantageously 0.005-1% calculated on the weight of the polymer.

3. A composition according to claim 1 wherein the polymer component can be a saturated or unsaturated polymer containing labile hydrogen atom such as advantageously a biopolymer consisting substantially of on lactic acid, capronic acid, glycolic acid or butyric acid based structural units, or a copolymer of those with all the variations, advantageously polylactic acid, polylactide, poly(ε-caprolactone), polyhydroxybutyrate or a mixture of these.

4. A composition according to claim 1 wherein the double bond containing silicon compound is advantageously alkoxyvinylsilane such as methoxysilane or ethoxysilane, among latter such as vinyltriethoxysilane, vinyltrimethoxysilane or vinyl(2-methoxyethoxy)silane, or it is methacrylate silane such as gamma-methacryloxypropyltrimethoxysilane or any other corresponding unsaturated alkoxysilanes.

5. A composition according to claim 1 wherein the heterophasic component is glass, bioactive glass, hydroxyapatite, other inorganic filler such as silica, microsilica, kaolin, aluminum hydroxide, magnesium hydroxide, metal surface such as steel, iron, aluminum or titanium.

6. A composition according to claim 1 wherein the 10 heterophasic component can be in the form of particles, chopped or continuous fibres, woven structures, sheets or plates or layered structures, laminates, or surface structures of a coating.

7. A composition according to claim 1 wherein the dimensions 15 of the heterophasic material can vary in widely from macroscopic particles or surfaces down to nanoparticles.

8. A composition according to claim 1 wherein the weight fraction of the polymer component can advantageously be in the range of 1-99%.

9. A method to manufacture heterophasic polymer composition in which the interfacial adhesion between the phases is improved wherein onto the polymeric component has been grafted a functional silicon compound that contains double bond.

10. A method to manufacture heterophasic polymer composition in which the interfacial adhesion between the phases is improved wherein a double bond containing functional silicon compound has been grafted through reaction of labile hydrogens of the polymeric component or the surface of a heterophasic component 30 has been treated with the double bond containing functional silicon compound that furthermore has been grafted onto the polymeric component through the reaction of a labile hydrogen atom.

11. (canceled)

12. A composition according to claim 1 wherein the silane component is used as an amount of 0.005-5% based on the weight of the polymer.
